(19) United States
(12) Patent Application Publication
(10) Pub. No.: US 2003/0168431 A1
(43) Pub. Date: Sep. 11, 2003

(54) Etchant composition for silver alloy

(75) Inventors: Hsu Fong Lee, Changhua (TW); Hsin Tzu Yao, Taipei (TW); Chung Che Chou, Taoyuan (TW); Ming Shih Chung, Dall City (TW); Tien Sheng Yeh, Hsinchu (TW); Chao Chin Wu, Taipei (JP)

Correspondence Address: BACON & THOMAS, PLLC, 625 SLATERS LANE, FOURTH FLOOR, ALEXANDRIA, VA, 22314

(73) Assignee: RITdisplay Corporation, Hsin Chu Industrial Park (TW)

(21) Appl. No.: 10/372,140

(22) Filed: Feb. 25, 2003

(30) Foreign Application Priority Data
Feb. 25, 2002 (TW) 91103331
May 20, 2002 (TW) 91110558

(51) Int. Cl. C23F 1/00; B44C 1/22; C03C 15/00; C03C 25/68

(52) U.S. Cl. 216/86

(57) ABSTRACT

A series of etchant compositions for silver alloy is disclosed. The etchant composition for silver alloy comprises 1 to 60 weight part(s) of hydrogen peroxide; 1 to 60 weight part(s) of sulfuric acid, nitric acid, or organic acid; and 5 to 90 weight part(s) of water Similar etchant composition for silver alloy is. also disclosed, which comprises. 1 to 60 weight part(s) of ammonium compound; 1 to 60 weight part(s) of hydrogen peroxide; and 0 to 96 weight part(s) of water. The etchant composition for silver alloy of the present invention can: etch silver alloy containing more than 80% of silver with a controlled etching rate selectively and effectively. Moreover, the method for using the foresaid etchant composition for silver alloy to form a patterned silver alloy is also disclosed therewith.

### BACKGROUND OF THE INVENTION

1. Field of the Invention

The present invention relates to an etchant composition, more particularly, the present invention relates to an etchant composition used for etching silver alloy.

2. Description of Related Art

Currently, chromium (Cr) is used for the electrical interconnection of flat panel display devices, especially for organic electro-luminescence display devices. But due to its high resistance for electrical conductance, researches are looking for new materials (or metals) with low electrical resistance for replacing it. In the past time, silver is proposed to be an ideal metal used for the inter-connection for flat panel display: devices. Nevertheless, since there was no ideal or applicable etchant composition used for forming a patterned silver: metal layer, silver was not widely used for interconnection materials so far.

In recent years, in order to improve the performance of flat panel display devices, researches still focused on lowering the electrical resistance of the conductor wires. So far, silver alloy is considered as an adequate candidate since the resistance of silver alloy is comparably lower than tat of other metals Besides, even though silver alloy containing silver more than 80% has a higher resistance than metal silver, it has a much lower resistance than Cr does. However, there is still no applicable etchant composition used for forming a patterned silver alloy

Therefore, it is desirable to provide an improved method to mitigate he aforementioned problems.

### SUMMARY OF THE INVENTION

The object of the present invention is to provide an etchant for silver alloy, so that the etching rate of the silver alloy containing more than 80% of silver could be controlled selectively and effectively, the patterned of silver alloy can be formed through lithography.

To achieve the object, the etchant for silver alloy of the present invention includes 1 to 60 weight part(s) of hydrogen peroxide; 1 to 60 weight part(s) of sulfuric acid, nitric acid, or organic acid; and 5 to 90 weight part(s) of water.

To achieve the object, the etchant for silver alloy of the present invention includes 1 to 60 weight part(s) of ammonium compound; 1 to 60 weight part(s) of hydrogen peroxide; and 0 to 96 weight part(s) of water.

To achieve the object, the method for forming patterned silver alloy of the present invention includes following steps: providing a substrate having a surface made of or coated with silver alloy; coating at least a layer of photoresist and forming patterned photoresist through. exposure said substrate to a radiation; and spreading an etchant composition for silver alloy on said surface made of silver alloy of said substrate or immersing said substrate having said surface made of silver alloy into said etchant composition for silver alloy; wherein said etchant composition for silver alloy comprising: 1 to 60 weight part(s) of hydrogen peroxide; 1 to 60 weight part(s) of sulfuric acid, nitric acid, or organic acid; and 5 to 90 weight parts of water

To achieve the object, the method for forming patterned silver alloy of the present invention includes the following steps: providing a substrate having a surface made of. or coated With silver alloy; providing a substrate having a surface made of or coated with silver alloy; coating at least a layer of photoresist and forming patterned photoresist through exposure said substrate to radiation; and. spreading an etchant composition for silver alloy on said surface made of silver alloy of said substrate or immersing said substrate having said surface made of silver alloy into said etchant for silver alloy; wherein said etchant composition for silver alloy comprising: 1 to 60 weight part(s) of ammonium compound; 1 to 60 weight part(s) of hydrogen. peroxide; and 0 to 96 weight part(s) of water.

Other objects, advantages, and novel features of the invention will become more apparent from the following detailed description.

### DETAILED DESCRIPTION OF THE PREFERRED EMBODIMENT

In one aspect, the. etchant composition of the. present invention mainly includes 1 to 60 weight part(s) of hydrogen peroxide, 1 to 60 weight part(s) of sulfuric acid, nitric acid, or organic acid; and 5 to 90 weight part(s) of water. Most preferably, the etchant composition of the present invention comprises 1 to 20 weight part(s) of hydrogen peroxide; 1 to 20 weight part(s) of ammonium compound; 1 to 20 weight part(s) of amino acid; and 5 to 90 weight part of water. The etchant composition of the present invention can optionally further comprise 1 to 20 weight part(s) of ammonium compound The ammonium compound usable in the present invention can be any ammonium compound, as long as it could provide ammonium ion in order to react with silver of the silver alloy (For example, forming silver-ammonium complex ion.) and benefit the etching of silver alloy. Preferably, the ammonium compound is ammonium sulphate, ammonium acetate, ammonium nitrate, or ammonium hydroxide. The organic acid used in the etchant composition for silver: alloy ,of the present invention is preferred to be amino acid. In the foresaid etchant composition, the amino acid is preferred to be glycine.

Another etchant composition of the present invention comprises, 1 to 60 weight part(s) of ammonium .compound, 1 to 60 weight part(s) of hydrogen peroxide; and 0 to 96 weight part(s) of water. The ammonium compound usable in the present invention is not limited, as long as it could provide ammonium ion in order to react with silver of the silver alloy (For example, forming silver-ammonium complex ion.) and benefit the etching of silver alloy. Preferably, the ammonium compound is ammonium sulphate, ammonium acetate, ammonium nitrate, or ammonium hydroxide. The etchant composition of the present invention can optionally comprise 1 to 10 weight part(s) of sulfuric acid, nitric: acid, or organic. acid. Preferably, the organic acid is phenol sulfonic acid or acetic acid.

### EXAMPLE 1-8

Solutions of the. present invention are made through mixing hydrogen peroxide with nitric acid according to the ratio listed in the table 1 below, and then adding water until the total amount of the mixture is 100 g. The etchants with various concentrations are prepared for further testing or applications. A Si-substrate with silver alloy metal film is coated with a layer of photoresist through spin coating. The silver alloy metal film is formed through sputtering over 98% of silver, 0.9% of palladium and over 1.0% of copper. The coated Si-substrate is then exposure to a radiation under a patterned mask. The exposed Si-substrate is then sprayed or immersed in the prepared etchant composition according to table 1. The etching rare is also measured as the silver metal film is etched. The results are also listed in table 1 below.

TABLE 1

| | | Hydrogen | Etching rate |
|---|---|---|---|
| Example | Nitric acid | peroxide | (Å/sec) |
| 1 | 5 | 10 | 10 |
| 2 | 5 | 15 | 11.2 |
| 3 | 15 | 10 | 8.3 |
| 4 | 15 | 15 | 26.5 |
| 5 | 15 | 25 | 32.2 |
| 6 | 15 | 50 | 107.1 |
| 7 | 30 | 25 | 25 |
| 8 | 30 | 50 | 52.6 |

We found the Si-substrates or patterned photo-resist were not destroyed by the etchants after the Si-substrates is carefully inspected. The etchants only selectively etched they silver alloy.

### EXAMPLE 9-23

Solutions of the present invention are made through mixing hydrogen peroxide with sulfuric acid according to the ratio listed. in the table 2 below, and then adding water until the total amount of the mixture is 100 g. The etchants with various. concentrations are prepared for further testing or applications. A Si-substrate With. silver alloy metal film is coated with a layer of photoresist through spin coating. The silver alloy metal film is formed through sputtering over 98% of silver, 0.9% of palladium and over 1.0% of copper. The coated Si-substrate is then exposure to a radiation under a patterned mask. The exposed Si-substrate is then sprayed or immersed in the prepared etchant composition according to table 2. The etching rate is also measured as the silver metal. film is etched. The results are also listed in table 2 below.

TABLE 2

| | | Hydrogen | Etching rate |
|---|---|---|---|
| Example | Sulfuric acid | peroxide | (Å/sec) |
| 9 | 30 | 5 | 5.5 |
| 10 | 30 | 10 | 41.6 |
| 11 | 30 | 15 | 33.3 |
| 12 | 25 | 5 | 5.3 |
| 13 | 25 | 10 | 15 |
| 14 | 25 | 15 | 18.8 |
| 15 | 20 | 5 | 2.9 |
| 16 | 20 | 10 | 10 |
| 17 | 20 | 15 | 27.3 |
| 18 | 10 | 10 | 6.2 |
| 19 | 10 | 15 | 3.5 |
| 20 | 10 | 30 | 4.2 |
| 21 | 8 | 50 | 9.1 |
| 22 | 2 | 30 | 11.2 |
| 23 | 0.5 | 30 | 16.6 |

We found that the Si-substrates or patterned photo-resist were not destroyed by the etchants. The. etchants only selectively etched the silver alloy.

### EXAMPLE 24-32

Solutions of the present invention are made through mixing hydrogen peroxide with sulfuric acid and ammonium: acetate according to the ratio listed in the table 3 below, and then adding water until the total amount of the mixture is 100 g. The etchants with various concentrations are prepared for further testing or applications. A Si substrate with silver alloy metal film is coated with a layer of photoresist through spin coating. The silver alloy metal film is formed through sputtering over 98% of silver, 0.9% of palladium and over 1.0% of copper. The coated Si-substrate is then exposure to radiation under a patterned mask. The exposed Si-substrate is then sprayed or immersed in the prepared etchant composition according to table 3. The etching rate is also measured as the silver metal film is etched. The results are also listed in table 3 below.

TABLE 3

| | Hydrogen | | Ammonium | Etching rate |
|---|---|---|---|---|
| Example | peroxide | Sulfuric acid | acetate | (Å/sec) |
| 24 | 8 | 2 | 2 | 46.15 |
| 25 | 8 | 2 | 5 | 46.15 |
| 26 | 8 | 2 | 8 | 24.19 |
| 27 | 8 | 4 | 2 | 32.25 |
| 28 | 8 | 4 | 5 | 6.31 |
| 29 | 8 | 4 | 8 | 10 |
| 30 | 8 | 3 | 2 | 14.28 |
| 31 | 8 | 3 | 5 | 54.54 |
| 32 | 8 | 3 | 8 | 28.57 |

We found that the Si-substrates or patterned photo-resist were not destroyed by the etchants. The etchants only selectively etched the silver: alloy.

### EXAMPLE 33-38

Solutions of the present invention are made through mixing hydrogen peroxide with glycine and: ammonium sulphate according to the ratio listed in the table 4 below,, and then adding water until the total amount of the mixture is 100 g. The etchants with various concentrations are prepared for further testing or applications. A Si-substrate with silver alloy metal film is coated with a layer of photoresist through spin coating. The silver alloy metal film is formed through sputtering over 98% of silver, 0.9% of palladium and over 1.0% of copper. The coated Si-substrate is then exposure to a radiation under a patterned mask. The exposed Si-substrate is then sprayed or immersed in the prepared etchant composition according to table 4. The etching rate is also measured as the silver metal film is etched. The results are also listed in table 4 below.

TABLE 4

| | Hydrogen | Ammonium | | Etching rate |
|---|---|---|---|---|
| Example | peroxide | sulphate | Glycine | (Å/sec) |
| 33 | 5 | 5 | 1 | 33.3 |
| 34 | 5 | 5 | 3 | 21.42 |
| 35 | 5 | 8 | 1 | 46.15 |
| 36 | 5 | 8 | 3 | 27.27 |
| 37 | 5 | 2 | 1 | 29.41 |
| 38 | 5 | 2 | 3 | 16.66 |

We found that the Si-substrates or patterned photo-resist were not destroyed by the etchants. The etchants only selectively etched the silver alloy.

### EXAMPLE 39-46

Solutions of the present invention are made through mixing hydrogen peroxide with ammonium peroxide according to the ratio listed in the table 4 below, and then adding water until the total amount of the mixture is 100 g. The etchants with various concentrations are prepared for further testing or applications. A Si-substrate with silver alloy metal film is coated with a layer of photoresist through spin coating. The silver alloy metal film is formed through sputtering over 98% of silver, 0.9% of palladium and over 1.0% of copper. The coated Si-substrate is then exposure to a radiation under a patterned mask. The exposed Si-substrate is then sprayed or immersed in the prepared etchant composition according to table 4. The etching rate is also measured as the silver metal film is etched. The results are also listed in table 5 below.

TABLE 5

| | ammonium | hydrogen | Etching rate | Etching time |
|---|---|---|---|---|
| Example | hydroxide | peroxide | (Å/sec) | (sec) |
| 39 | 7.5 | 7.5 | 63.8 | 47 |
| 40 | 6 | 6 | 60 | 50 |
| 41 | 5 | 5 | 20 | 150 |
| 42 | 4 | 4 | 8.8 | 340 |
| 43 | 50 | 50 | 2000 | 1.5 |
| 44 | 50 | 25 | 1500 | 2 |
| 45 | 25 | 50 | 2000 | 1.5 |
| 46 | 25 | 25 | 1200 | 2.5 |

### EXAMPLE 47-61

Solutions of the present invention are made through mixing hydrogen peroxide with ammonium peroxide. and phenol sulfonic acid according to the ratio listed in the table 4 below, and then adding water until.. the total amount of the mixture is 100 g. The etchants with various concentrations are prepared for further testing or applications. A Si-substrate with silver alloy metal. film is coated with a layer of photoresist through spin coating. The silver alloy metal film is formed through sputtering over 98% of silver, 0.9% of palladium and over 1.0% of copper. The coated Si-substrate is then exposure to a radiation under a patterned mask. The exposed Si-substrate is then is prayed or immersed in the prepared etchant composition according to table 6. The etching rate is also measured as the silver metal film is etched. The results are also listed in table 6 below.

TABLE 6

| | | | Phenol | | Etching |
|---|---|---|---|---|---|
| | Ammonium | Hydrogen | sulfonic | Etching rate | time |
| Example | hydroxide | peroxide | acid | (Å/sec) | (sec) |
| 47 | 7 | 7 | 3 | 100 | 30 |
| 48 | 5 | 5 | 3 | 27.5 | 109 |
| 49 | 3 | 3 | 3 | 13.6 | 220 |
| 50 | 7 | 7 | 2 | 81 | 37 |
| 51 | 5 | 5 | 2 | 22.9 | 131 |
| 52 | 3 | 3 | 2 | 13.8 | 216 |
| 53 | 4 | 2 | 2 | 8.3 | 7.5 |
| 54 | 4 | 3 | 2 | 12.29 | 13.04 |
| 55 | 4 | 4 | 2 | 36.58 | 37.03 |
| 56 | 2 | 3 | 2 | 66.66 | 50 |
| 57 | 3 | 3 | 2 | 12 | 16.3 |
| 58 | 4 | 3 | 2 | 16 | 15 |
| 59 | 5 | 3 | 2 | 16.3 | 16 |
| 60 | 6 | 3 | 2 | 21.1 | 21.4 |
| 61 | 7 | 3 | 2 | 21.1 | 24.3 |

From the above data we conclude that the etchant of the present invention can etch the silver alloy effectively and selectively accompanying with very minor effect or without damaging on the substrate. Moreover, the rate of etching can be adjusted or controlled by adjusting etching time or the concentration of the etchant. Besides, by combining the echant composition of the present invention and the lithography process, a patterned film of silver alloy can be formed easily in: the manufacturing process of micro-electromechanical system, chip, or panels of flat panel display devices.

Although the present invention has been explained in relation to its preferred embodiment, it is to be understood that many other possible modifications and variations can be made without departing from the spirit and scope of the invention as hereinafter claimed.

What is claimed is:

1. A composition for etching a silver alloy comprising:
1 to 60 weight part(s) of hydrogen peroxide;
1 to 60 weight part(s) of sulfuric acid, nitric acid, or organic acid; and
5 to 90 weight part(s) of water.

2. The composition as claimed in claim 1, filter comprising 1 to 20 weight part(s) of ammonium: compound.

3. The composition as. claimed in claim 2, wherein said ammonium compound is ammonium sulphate, ammonium acetate, ammonium nitrate, or ammonium hydroxide.

4. The composition as: claimed in claim 1, wherein said organic acid is an amino acid.

5. The composition as claimed in claim 2, comprising:
1 to 20 weight part(s) of hydrogen peroxide;
1 to 20 weight part(s) of ammonium compound;
1 to 20 weight part(s) of amino acid; and:
5 to 90 weight part of water.:

6. The composition as claimed in claim 5, wherein said amino acid is glycine.

7. A composition for, etching a silver alloy comprising
1 to 60 weight part(s) of ammonium compound;
1 to 60 weight part(s) of hydrogen peroxide; and
0 to 96 weight part(s) of water.

8. The composition: as claimed in claim 7, wherein: said ammonium compound is ammonium sulphate, ammonium acetate, ammonium nitrate, ammonium hydroxide.

9. The composition as claimed in claim 7 further comprising 1 to 10 weight part(s) of sulfuric acid; nitric acid, or organic acid.:

10. The composition as claimed in claim 9, wherein said organic acid is phenol sulfonic acid or acetic acid.

11. A method for forming patterned silver alloy comprising following steps:
providing a substrate having a surface made of or coated with silver alloy;
coating at least a layer of photoresist and forming patterned photoresist through exposure said substrate to a radiation; and
spreading an etchant composition for silver alloy on said surface made of silver alloy of said substrate or immersing said substrate having said surface made of silver alloy into said etchant composition for silver alloy;
wherein said etchant composition for silver alloy comprising: 1 to 60 weight part(s) of hydrogen peroxide; 1 to 60 weight part(s) of sulfuric acid, nitric acid, or organic acid; and 5 to 90 weight parts of water:

12. The method as claimed in claim 11, wherein said etchant compostition for silver alloy further comprises 1 to 20 weight part(s) of ammonium compound.

13. The method as claimed in claim 12, wherein said ammonium compound is ammonium sulphate, ammonium acetate, ammonium nitrate, or ammonium hydroxide.

14. The method as claimed in claim 11, wherein said organic acid is an amino acid.

15. The method as :claimed in claim 12, wherein said etchant composition for silver alloy comprises
1 to 20 weight part(s) of hydrogen peroxide;
1 to 20 weight part(s) of ammonium compound;
1 to 20 weight part(s) of amino acid; and
5 to 90 weight part of water.

16. The method as claimed in claim 15, wherein said amino acid is glycine.

17. A method for forming patterned silver alloy comprising the following steps:
providing a substrate having a surface made of or coated with silver alloy;
coating at least a: layer of photoresist and forming patterned photoresist through exposure said substrate to radiation; and
spreading an etchant composition for silver alloy on said surface made of silver alloy of said substrate or immersing said substrate having said surface made of silver alloy into said etchant for silver alloy;
wherein said etchant composition for silver alloy comprising: 1 to 60 weight part(s) of ammonium compound; 1 to 60 weight part(s) of hydrogen peroxide; and 0 to 96 weight part(s) of water.

18. The method as claimed in claim 17, wherein said ammonium compound is ammonium sulphate, ammonium acetate, ammonium nitrate, or ammonium hydroxide.

19. The method as claimed in claim 17, wherein said etchant composition for silver alloy further comprises 1 to 10 weight part(s) of sulfuric acid, nitric acid, or organic acid.

20. The method as claimed in claim 19, wherein said organic acid is phenol sulfonic acid or acetic acid.
